(19) United States
(12) Patent Application Publication
(10) Pub. No.: US 2025/0339816 A1
(43) Pub. Date: Nov. 6, 2025

(54) LOW TEMPERATURE ACID GAS REMOVAL SYSTEM

(71) Applicant: Saudi Arabian Oil Company, Dhahran (SA)

(72) Inventors: Guillaume Robert Jean-Francois Raynel, Dhahran (SA); Khadijah Ghazi Alshadly, Dhahran (SA)

(21) Appl. No.: 18/652,437

(22) Filed: May 1, 2024

(51) Int. Cl. B01D 53/78; B01D 53/14; B01D 53/62

(52) U.S. Cl. CPC B01D 53/78; B01D 53/1425; B01D 53/62; B01D 2257/504; B01D 2258/0283

(57) ABSTRACT

A system and method for acid gas removal are provided. An exemplary system includes a contactor that includes an inlet for an aqueous carbonate stream proximate to a top of the contactor, wherein the aqueous carbonate stream includes a catalyst. The contactor also includes an inlet for a gas stream proximate to a bottom of the contactor, wherein the gas stream includes an acid gas. Further, the contactor includes an outlet for an aqueous bicarbonate-carbonate stream proximate to the bottom of the contactor, and an outlet for a sweetened gas stream proximate to the top of the contactor. The acid gas removal system also includes a nanofilter. The aqueous bicarbonate-carbonate stream is introduced at an inlet to the nanofilter, and a permeate stream from the nanofilter is fed to a flash column. The nanofilter also provides a retentate stream including carbonate ions, wherein the retentate stream is fed to the contactor.

### TECHNICAL FIELD

This disclosure relates to methods of removing acid gases from gas streams in absorption reactions.

### BACKGROUND

Carbon dioxide capture is an increasing topic of interest, mainly due to the international policy on climate change. It is also an area of interest in the oil and gas industry, as amine processes are energy consumers. This is mainly due to the temperature of regeneration of the acid gas-rich absorbent. The temperature of regeneration is the temperature threshold at which the acid gases are released from the aqueous sorbent solution and steam stripping. Research has continued on low regeneration temperature amine, though the lowest temperature reached has above 70° C. or 343K.

### SUMMARY

An embodiment described herein provides an acid gas removal system. The acid gas removal system includes a contactor that includes an inlet for an aqueous carbonate stream proximate to a top of the contactor, wherein the aqueous carbonate stream includes a catalyst. The contactor also includes an inlet for a gas stream proximate to a bottom of the contactor, wherein the gas stream includes an acid gas. Further, the contactor includes an outlet for an aqueous bicarbonate-carbonate stream proximate to the bottom of the contactor, and an outlet for a sweetened gas stream proximate to the top of the contactor. The acid gas removal system also includes a nanofilter. The nanofilter includes the aqueous bicarbonate-carbonate stream introduced at an inlet, a permeate stream including bicarbonate ions, wherein the permeate stream is fed to a flash column. The nanofilter also includes a retentate stream including carbonate ions, wherein the retentate stream is fed to the contactor.

Another embodiment described herein provides a method for removing an acid gas from a sour stream. The method includes introducing a gas proximate to a bottom of a contactor, wherein the gas includes a mixture with an acid gas. An aqueous carbonate stream is introduced proximate to a top of the contactor, wherein the aqueous carbonate stream includes a monovalent ion and an alkaline earth ion. The gas and the combined aqueous stream are contacted in a countercurrent flow in the contactor, forming a sweetened gas and an aqueous bicarbonate-carbonate stream. A sweetened gas stream is removed proximate to the top of the contactor. The aqueous bicarbonate-carbonate stream is removed proximate to the bottom of the contactor. The aqueous bicarbonate-carbonate stream is passed through a nanofilter. The permeate stream from the nanofilter is provided to a flash column. The permeate stream is regenerated in the flash column to reform the aqueous carbonate stream. The retentate stream from the nanofilter is introduced to the absorption column.

### BRIEF DESCRIPTION OF DRAWINGS

FIGS. 1A and 1B are schematic drawings of the catalytic reactions of the regeneration involved in the process.

FIG. 2 is a block figure of a carbon dioxide (CO₂) removal system.

FIG. 3 is a schematic drawing of an acid gas removal system.

FIG. 4 is a schematic drawing of a system for removing CO₂ from air.

FIG. 5 is a block diagram of a process for removing acid gases using alkaline carbonates, a promoter (carbonic anhydrase) and a decarboxylation catalyst (alkaline earth carbonates).

FIG. 6 is a plot comparing the decarboxylation of a sodium bicarbonate solution with and without using a catalyst (magnesium carbonate).

### DETAILED DESCRIPTION

Embodiments described herein provide a method and a system in which a catalyst is used to free an absorbed acid gas at low temperature, for example, at about 55° C. for carbon dioxide (CO₂). Additionally, a nanofilter is used to concentrate a bicarbonate stream which reduces the regenerator size and the boiler duty. In comparison to conventional methods for capturing CO₂, such as an amine process or potassium carbonate, the regeneration temperature is lower, providing energy savings. The techniques also allow for a size reduction of a regeneration, or flash, column, which lowers the capital costs.

The process provides a simple and selective direct carbon capture, generally without the use of amines. Accordingly, the carbon dioxide formed is free of residual amines and can be directly used for EOR or other purposes, without further processing.

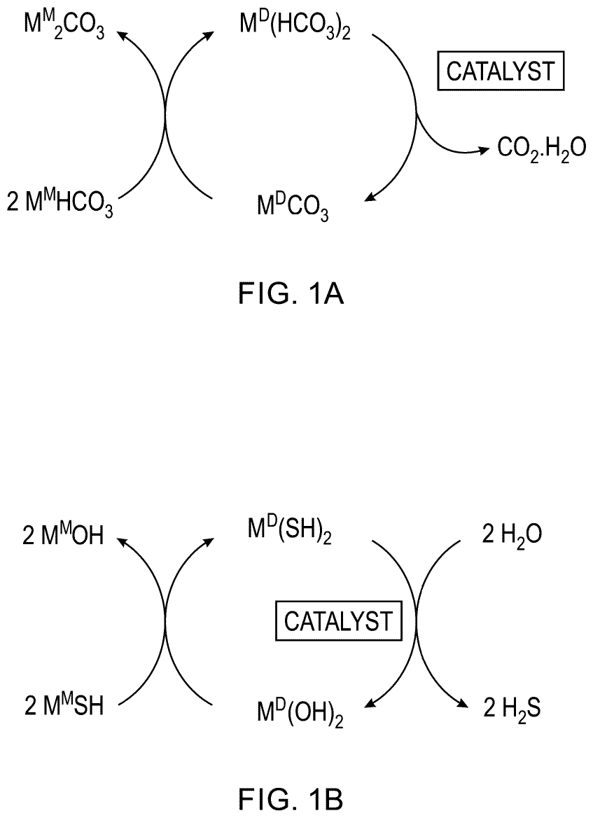

FIGS. 1A and 1B are schematic drawings of the catalytic reactions of the regeneration involved in the process. In the techniques described herein, the bicarbonate/carbonate cycle and the notion of scaling due to hardness are used to lower the energy demand of the regeneration step.

FIG. 1A is the absorption/desorption reactions for carbon dioxide. The monovalent metal, shown as M^{M} herein, is from the Alkali metal (Group I of the periodic table), including lithium, sodium, potassium, cesium, rubidium, and sodium. In some embodiments, the metal M^{M} is at least partially replaced by amines that produce bicarbonate ammonium salts when reacted with carbon dioxide. These amines belong to the nitrogen-containing heteroaromatic and hindered amine families. The bicarbonate of these sorbents decarboxylates at high temperature (>100° C. or >373 K), though they have a large loading capacity due to the high solubility of their bicarbonate species.

The metal M^{D} is from the alkaline earth metals (Group 2 of the periodic table), preferably magnesium and calcium. The bicarbonate of these metals decarboxylates at low temperature (50-55° C. or 323-328 K) but were never considered for carbon dioxide capture due to the low solubilities of their respective carbonate and bicarbonate salts. For example, hard water scaling in pipes is a consequence of the chemistry explained above. This disadvantage can be overcome by introducing a cation exchange reaction and by using a divalent metal, such as Ca²⁺ or Mg²⁺, shown as M^{D} herein, as a regeneration catalyst.

The system is used with carbonic anhydrase as an absorption catalyst, term a promote. This enzyme facilitates the CO₂ absorption, but decomposes above about 80° C. Accordingly, the use of the regeneration catalyst (MgHCO₃⁺) provides a synergistic effect, in which the regeneration catalyst is compatible with the carbonic anhydrase and can decarboxylate at low temperature (+50° C.), sparing the carbonic anhydrase from thermal decomposition.

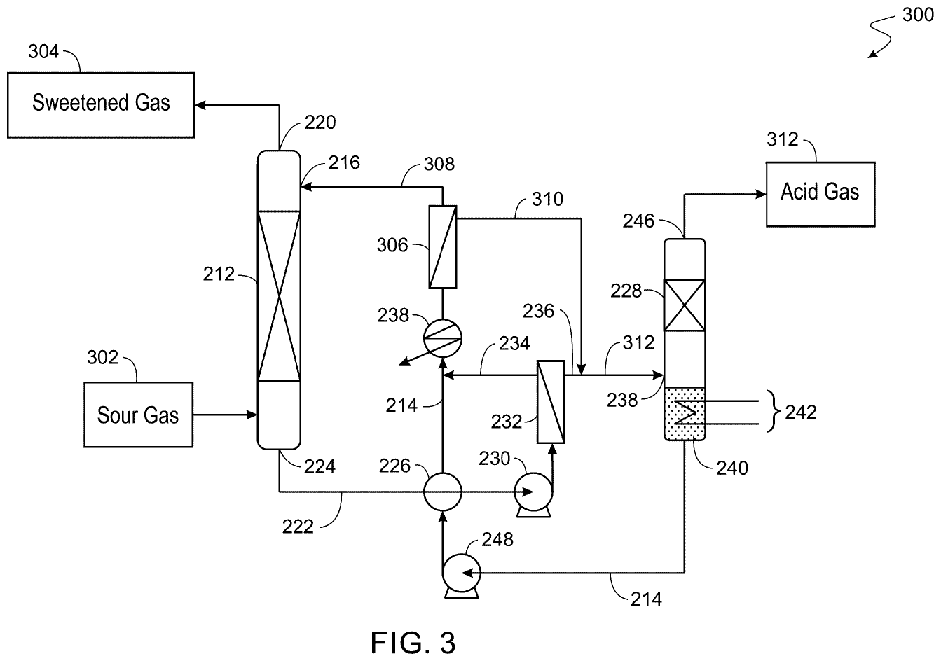

FIG. 1B is an example of a catalytic dehydrosulfidation reaction. The two processes may be performed together as described with respect to FIG. 3.

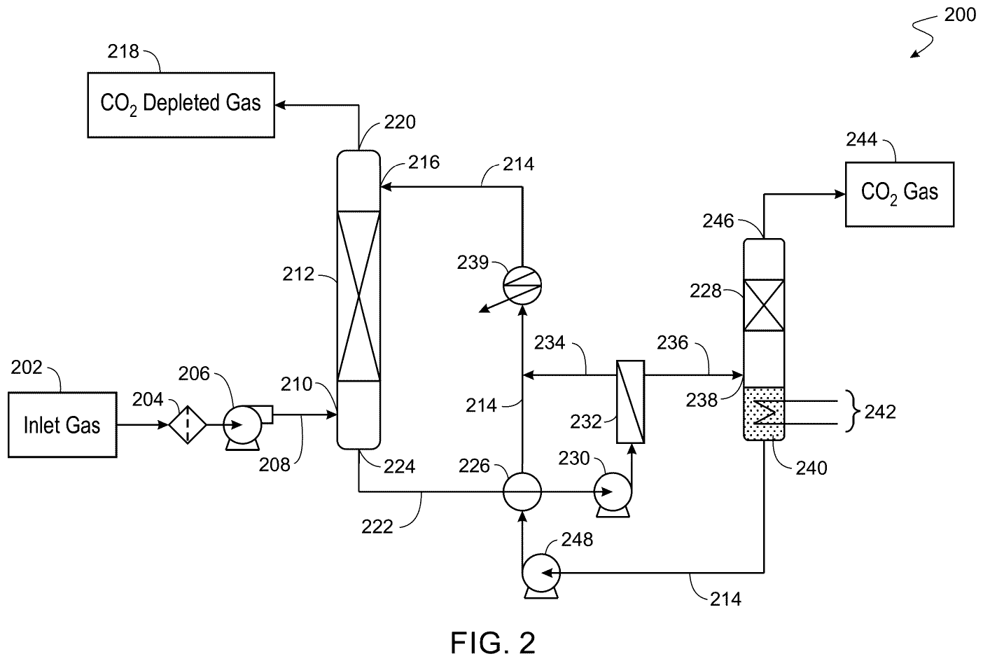

FIG. 2 is a block figure of a CO₂ removal system 200. An inlet gas stream 202 is fed to the CO₂ removal system 200. As used herein, the inlet gas stream 202 includes any gas that includes CO₂ that can be removed. The inlet gas stream 202 can include natural gas, air, flue gas, or other gas streams that can be processed to remove CO₂.

In some embodiments, the inlet gas stream 202 is passed through a filter 204 to remove solid particles, such as dust, that are entrained in the inlet gas stream 202. A compressor 206 is then used to inject the filtered stream 208 through an inlet 210 at the bottom of a contactor 212. An aqueous carbonate stream 214 is injected into the contactor 212 through an inlet 216 proximate to the top of the contactor 212. The temperature of the aqueous carbonate stream 214 is between about between about 1° C. and about 49° C., between about 5° C. and about 45° C., between about 10° C. and about 40° C., between about 20° C. and about 35° C. or between about 20° C. and about 25° C.

The aqueous carbonate stream 214 passes through the contactor 212 counter-current to the filtered stream 208. A CO₂ depleted gas stream 218 exits the contactor 212 through an outlet 220 proximate to the top of the contactor 212. As used herein, the CO₂ depleted gas stream 218 can include natural gas or air, among other gases, after the removal of carbon dioxide.

An aqueous bicarbonate-carbonate stream 222 exits the contactor 212 through an outlet 224 proximate to the bottom of the contactor 212. The aqueous bicarbonate-carbonate stream 222 is passed through an economizer 226 in order to recover some heat from the aqueous carbonate stream 214 exiting a flash column 228. A pump 230 then passes the aqueous bicarbonate-carbonate stream 222 into a nanofilter 232. The nanofilter can include, for example, the NF40 nanofiltration membrane from DOW® Filmtec, among others.

The nanofilter 232 separates the aqueous bicarbonate-carbonate stream 222 into a retentate stream 234, which is enriched in carbonate ions, and a permeate stream 236, which is enriched in bicarbonate ions. In this embodiment, the retentate stream 234 is combined with the aqueous carbonate stream 214 from the economizer 226 and passed through a cooler 239 to lower the temperature before the aqueous carbonate stream 214 is returned to the contactor 212.

The retentate stream 234, which is high in bicarbonate, is introduced to the flash column 228 through an inlet 238 proximate to the bottom of the flash column 228. The aqueous solution 240 at the bottom of the column is heated, for example, to a temperature of between about 45° C. and about 65° C., between about 50° C. and about 60° C., or between about 55° C. and about 65° C. to release carbon dioxide. In the embodiment shown in FIG. 2, this is performed using a heat exchanger 242. The heat to the heat exchanger 242 can be recovered heat from another process, such as low-pressure steam or hot water. In some embodiments, the heat can be renewable heat from the sun, for example, in tropical climate. This is described further with respect to FIG. 3.

The heating of the aqueous solution 240 frees a CO₂ gas stream 244, which exits the flash column 228 through an outlet 246 proximate to the top of the flash column 228. In this embodiment, the removal of the carbon dioxide regenerates the aqueous carbonate stream 214, which is sent to a pump 248. The aqueous carbonate stream 214 exiting the pump 248 is passed through the economizer 226, combined with the retentate stream 234, and sent to the cooler 239. The cold source can be the ambient air in continental climates or a body of water, such as a sea or the ocean, in tropical climate. The aqueous carbonate stream 214 exiting the cooler is then introduced into the contactor 212 through the inlet 216. The contactor can be a falling-film column, a packed column, a bubble column, a spray tower, or gas-liquid agitated vessel, about others. The flash column can be a demister, a packed column, or an agitated vessel, among others. The process can be used to remove CO₂ from the atmosphere for sequestration or sale.

The aqueous carbonate stream is not limited to socially including alkaline metals, alkaline earth metals, carbonates, and bicarbonates, but may include other compounds, such as amines, as described with respect to FIGS. 1A and 1B.

FIG. 3 is a schematic drawing of an acid gas removal system 300. Like numbered items are as described with respect to FIG. 2 as used herein, an acid gas includes carbon dioxide, hydrogen sulfide, or mixture of both. Further, the term sour gas indicates a gas that includes an acid gas, for example, in an amount of less than about 40 vol. %, 10 vol. %, 5 vol. %, 2 vol. %, or less.

The sour gas stream 302 is injected at the bottom of the contactor 212. The aqueous carbonate stream 308 is introduced into the contactor 212 through an inlet 216 proximate to the top of the contactor 212. The aqueous carbonate stream 308 and the sour gas stream 302 pass through the contactor 212 in a countercurrent flow. At the top of the contactor, a sweetened gas stream 304 exits the contactor 212 through an outlet 220. An aqueous bicarbonate-carbonate stream 222 exits the bottom of the contactor 212 through outlet 224 and is passed through an economizer 226 to recover some heat from the aqueous carbonate stream 214 exiting the flash column 228.

From the economizer 226, the aqueous bicarbonate-carbonate stream 222 is sent to a pump 230. From the pump 230, the aqueous bicarbonate-carbonate stream 222 is sent to a nanofilter 232, for example, including a nanofiltration membrane, such as the NF40 membrane from DOW® Filmtec, among others. The nanofilter 232 separates the aqueous bicarbonate-carbonate stream 222 into a retentate stream 234, which is enriched in carbonate, and a permeate stream 236, which is enriched in bicarbonate. The retentate stream 234 is combined into the aqueous carbonate stream 214 and sent to the cooler 238.

After the cooler 238, the aqueous carbonate stream 214 is passed through a second nanofilter 306. The second nanofilter 306 includes a nanofiltration membrane, such as the NTR-729 HF from Nitto Denco, among others. The second permeate stream 308 from the second nanofilter 306, is introduced back into the contactor 212 through the inlet 216.

The second nanofilter 306 generates a second retentate stream 310, which is enriched in hydrosulfide. The permeate stream 236 from the nanofilter 232 is mixed with the second retentate stream 310 from the second nanofilter 306, which is loaded with the regeneration catalyst.

As discussed herein, carbonic anhydrase is used in combination with the regeneration catalyst, which is generally magnesium carbonate or calcium carbonate. While, the carbonic anhydrase is usually used only for CO₂ absorption, bonding energies indicate that it may increase the absorption of H₂S.

The mass concentration of carbonic anhydrase can range between 10 microgram per Liter (mcg/L) and 1 gram per Liter (g/L), or between about 500 mcg/L and about 500 mg/L. The mass concentration of the regeneration catalyst, e.g., magnesium carbonate or calcium carbonate, can range between about 10 mcg/L and about 500 mg/L, or between about 100 mcg/L and 100 mg/L.

The mixed stream 312 is then introduced through the inlet 238 into the flash column 228. Depending on the hydrosulfide ion concentration, the second retentate stream 310 can be sent directly to the flash column 228 to avoid potential scaling of magnesium hydrosulfide (Mg(SH)₂— Solubility<0.13 g/L) or magnesium sulfide (MgS) in piping.

The magnesium hydrosulfide will free H₂S at a temperature ranging between about 65° C. and about 80° C., or between about 70° C. and about 75° C. The magnesium bicarbonate will free CO₂ at a temperature ranging between about 45° C. and about 65° C., or between about 55° C. and about 65° C. In this embodiment, the aqueous solution 240 at the bottom of the flash column 228 is heated to these temperatures by the heat exchanger 242, providing the energy for the separation of hydrogen sulfide, as well as carbon dioxide. The heating of the aqueous solution 240 frees the acid gases, and an acid gas stream 312 exits the flash column 228 through an outlet 246 proximate to the top of the flash column 228.

The contactor can be a falling-film column, a packed column, a bubble column, a spray tower, or gas-liquid agitated vessel. The flash column can be a demister, a packed column, or an agitated vessel.

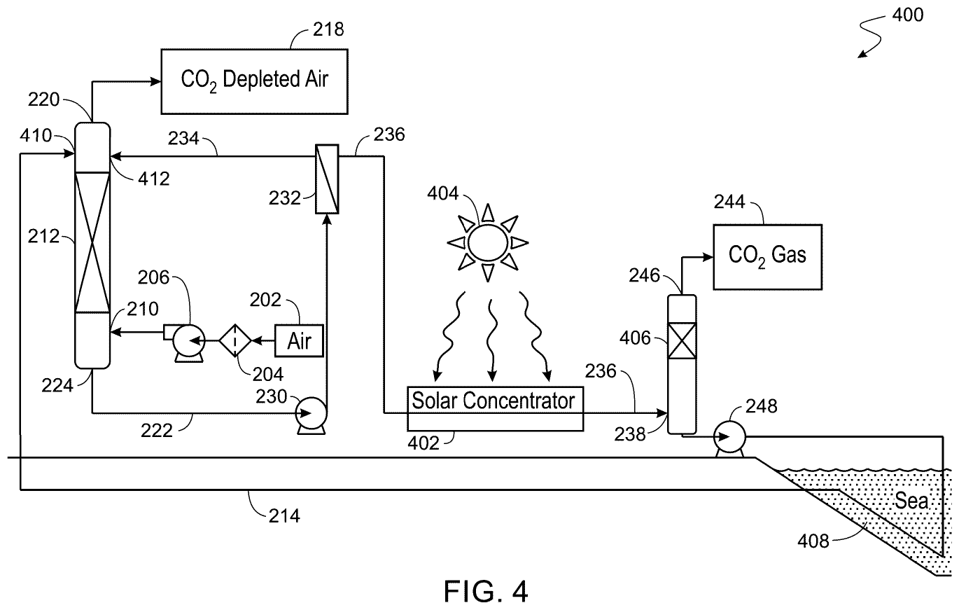

FIG. 4 is a schematic drawing of a system 400 for removing carbon dioxide from air. Like numbered items are as described with respect to FIG. 2. As described herein, at least a portion of the energy used may be provided from renewable resources. In various embodiments, the heat to regenerate the aqueous carbonate solution can be provided by the sun, for example, using a solar concentrator 402.

The solar concentrator 402 can be heated by focusing the rays of the sun 404 on a pipe carrying the permeate stream 236 from the nanofilter 232. For example, a parabolic mirror can be placed under the pipe to focus the rays, a Fresnel lens can be placed over the pipe to focus the rays, or a combination thereof. The solar concentrator 402 can be rotated to track the sun during the daylight hours. In some embodiments, the insolation is high enough that simpler devices, such as solar heaters, can be used. The permeate stream 236 can be heated by the solar concentrator 402 to between about 45° C. and about 65° C., between about 50° C. and about 60° C., or between about 55° C. and about 65° C.

After heating, the permeate 236 is introduced to a flash column 406 through an inlet 238. The CO₂ flashes from the aqueous solution in the flash column 406, and a CO₂ gas stream 244 is removed from an outlet 246 proximate to the top of the flash column 406.

For operations at night, a solar concentrator may be used to heat a storage fluid, such as a phase change material (PCM). The PCM can then be used in a heat exchanger to heat a flash column, such as the heat exchanger 242, described with respect to FIG. 2. Excess phase change material can be stored in an insulated tank, and used to power the process during periods when the sun is not shining. Furthermore, this would allow the use of a flash column 228 (FIG. 2) that is more commonly used in acid gas removal systems, lowering capital costs.

After removal of carbon dioxide, the aqueous carbonate stream 214 exits the flash column 406. In this embodiment, the aqueous carbonate stream 214 is cooled by circulating through a body of water 408, such as a lake, a river, or the ocean, among others. The circulation line for the aqueous carbonate stream 214 can include a heat exchanger below the surface of the body of water 408 to increase the efficiency. After cooling, the aqueous carbonate stream 214 is introduced into the contactor 212 through an inlet 410.

The retentate stream 234 from the nanofilter 232 is introduced into the contactor 212 through a second inlet 412. In some embodiments, the retentate stream 234 is combined with the aqueous carbonate stream 214, with the combined stream being introduced into the contactor 212 through a single inlet 216, as described with respect to FIG. 2.

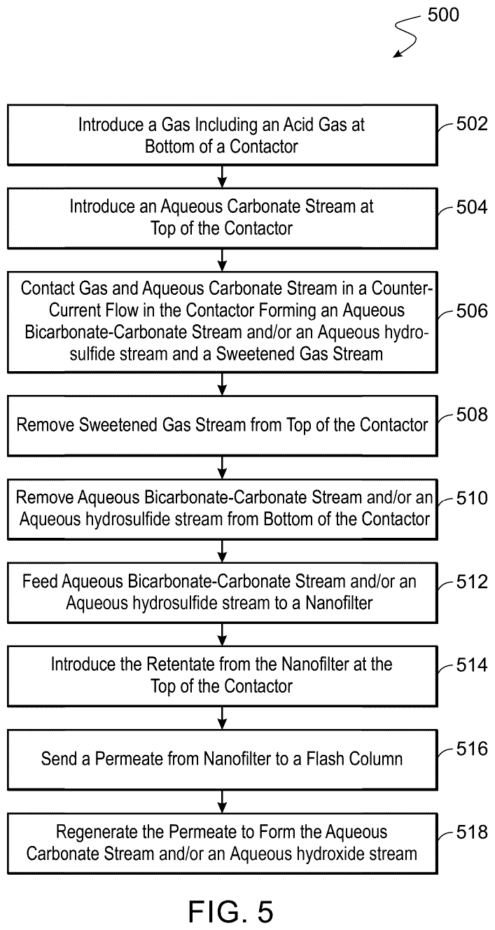

FIG. 5 is a block diagram of a process 500 for removing acid gases using alkaline carbonates, a promoter (carbonic anhydrase) and a decarboxylation catalyst (alkaline earth carbonates). An aqueous solution of alkaline metal and catalytic amount of alkaline earth metal absorbs CO₂, H₂S, or both from gas streams with or without a promoter, with the exception of strontium and barium which do not work in the application. The promoter increases the absorption rate of the carbonates, improving the efficiency of the process. The promoter can be enzymatic, organic, or inorganic, and the promoter described herein is an enzyme, carbonic anhydrase. The nanofilter separates the carbonates from the bicarbonates, functioning as a concentration step for the catalyst to work better. The carbonates are returned to the absorption vessel, while the bicarbonates are sent to a regeneration vessel. The catalyst can work at level as low as 10 microgram/L, and decarboxylates bicarbonates to give carbonates and CO₂ or dehydrosulfides with water to give the catalyst (magnesium hydroxide) and H₂S, at relatively low temperature, for example, about 45° C. to about 55° C. for CO₂, or 65° C. to 75° C. for H₂S. Thus, the process is thermally (or thermodynamically) selective (CO₂ vs H₂S) on the regeneration step, as compared to the amine methyldiethanolamine (MDEA) which is kinetically selective on the absorption step.

The catalyst can include calcium, magnesium, or beryllium salts. Generally, calcium or magnesium salts, as beryllium decarboxylates at about 20° C. which is the same temperature as the CO₂ capture. However, beryllium salts may be useful in colder environments, such as Russia or Canada, among others.

The carbonic anhydrase is also an absorption catalyst, termed a promoter, herein, as it promotes or accelerates the absorption of the CO₂. Other promoters for the absorption may be used, such as an amino acid (which are organic promoters) and vanadates or borates (which are inorganic promoters).

The process 500 begins at block 502 with the introduction of a gas that includes an acid gas, such as carbon dioxide or hydrogen sulfide, at the bottom of a contactor. At block 504, an aqueous carbonate stream is introduced at the top of the contactor. As described herein, in various embodiments, the aqueous carbonate stream includes alkaline metals, alkaline earth metals, amines, a promoter (carbonic anhydrase) and a regeneration catalyst (alkaline earth carbonates), or any combinations thereof. At block 506, the gas and the aqueous carbonate stream are contacted in a countercurrent flow in the contactor, forming an aqueous bicarbonate-carbonate stream and a sweetened gas. As used herein, a sweetened gas is a gas from which a substantial portion of the acid gases have been removed. The sweetened gas can include sweetened natural gas or air from which CO₂ has been removed, among others.

At block 508, a sweetened gas stream is removed from the top of the contactor. At block 510, an aqueous bicarbonate-carbonate stream is removed from the bottom of the contactor.

At block 512, the aqueous bicarbonate-carbonate stream is fed to a nanofilter. The nanofilter separates the aqueous bicarbonate-carbonate stream into a permeate, that is enhanced in bicarbonate, and a retentate stream that is enhanced in carbonate. As used herein, bicarbonate indicates bicarbonate anions, which may be present in a solution with alkaline cations, alkaline earth cations, amine cations, or any combinations thereof. As used herein, carbonate indicates carbonate anions, which may be present in a solution with alkaline cations, alkaline earth cations, amine cations, or any combinations thereof. At block 514, the retentate stream from the nanofilter is introduced at the top of the contactor. In various embodiments, this is in a blend with the aqueous carbonate stream. However, the retentate stream can be introduced separately from the aqueous carbonate stream.

At block 516, a permeate stream from the nanofilter is sent to a flash column. At block 518 the permeate stream is regenerated to form the aqueous carbonate stream. As used herein, regeneration indicates that the permeate stream is heated to release acid gases from the bicarbonate enhanced solution, reforming an aqueous carbonate. An aqueous carbonate stream is then returned to block 504 to continue the process 500.

### Examples

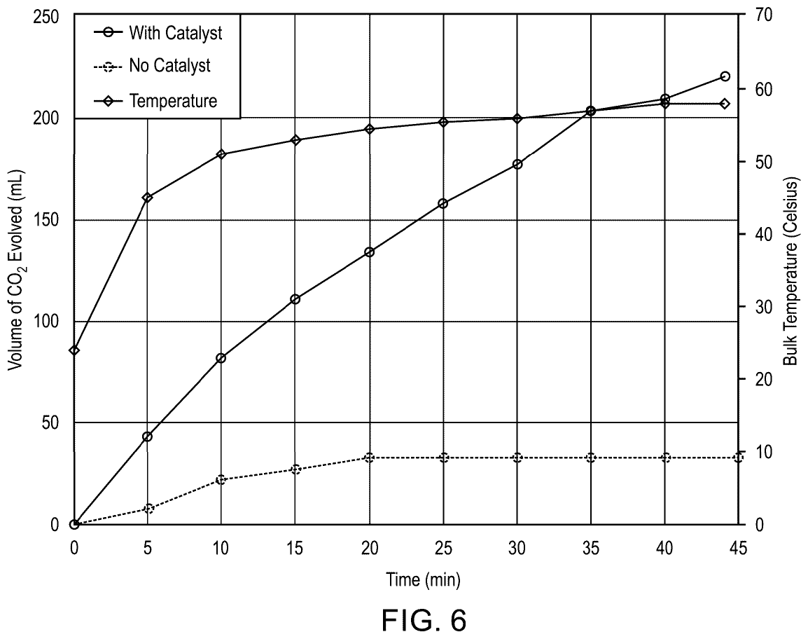

FIG. 6 is a plot comparing the decarboxylation of a sodium bicarbonate solution with and without using a catalyst (magnesium carbonate). Sodium bicarbonate was obtained from Acros Organics (+99%) and used without further purification. Magnesium carbonate was obtained from Sigma-Aldrich and used without further purification. The catalyst tested in Example 2 was magnesium carbonate, available from Sigma-Aldrich, and used without further purification.

### Example 1: No Catalyst

In a two-necked round bottom flask, 34.0725 g of sodium bicarbonate (0.4055 mol) was added to 100.0142 g of distilled water at room temperature. The aqueous suspension was stirred and heated at 55° C. The gas evolution was collected in an up-side-down 250-mL graduated cylinder, initially filled with water and plunged in a 500-mL crystallizer. The volume displaced was recorded as a function of time. In this experiment, a small volume of water vapor displaced 33 mL of water, which is due to the increase of vapor in the flask. A plateau was reached after 20 minutes.

### Example 2: With Catalyst

In a two-necked round bottom flask, 0.0388 g of magnesium carbonate (0.4601×10⁻³ mol) was added to 100.0748 g of distilled water at room temperature. After dissolution of the catalyst (i.e., magnesium carbonate), 34.0646 g of sodium bicarbonate (0.4055 mol) was added to the aqueous solution at room temperature. A few early bubbles of carbon dioxide were observed. The aqueous suspension was stirred and heated at 55° C. The gas evolution was collected in an up-side-down 250-mL graduated cylinder, initially filled with water and plunged in a 500-mL crystallizer. The volume displaced was recorded as a function of time. In this experiment, a large volume of CO₂ and water vapor displaced 220 mL of water, which is mainly due to the decarboxylation of bicarbonate (plus the 33 mL displaced by the water vapor). After 45 minutes, no plateau was reached compared to the example without catalyst.

### Embodiments

An embodiment described herein provides an acid gas removal system. The acid gas removal system includes a contactor that includes an inlet for an aqueous carbonate stream proximate to a top of the contactor, wherein the aqueous carbonate stream includes a catalyst. The contactor also includes an inlet for a gas stream proximate to a bottom of the contactor, wherein the gas stream includes an acid gas. Further, the contactor includes an outlet for an aqueous bicarbonate-carbonate stream proximate to the bottom of the contactor, and an outlet for a sweetened gas stream proximate to the top of the contactor. The acid gas removal system also includes a nanofilter. The nanofilter includes the aqueous bicarbonate-carbonate stream introduced at an inlet, a permeate stream including bicarbonate ions, wherein the permeate stream is fed to a flash column. The nanofilter also includes a retentate stream including carbonate ions, wherein the retentate stream is fed to the contactor.

In an aspect, the gas stream includes natural gas. In an aspect, the gas stream includes air. In an aspect, the gas stream includes a flue gas.

In an aspect, the sweetened gas stream includes carbon dioxide depleted air/gas.

In an aspect, combinable with any other aspect, the acid gas removal system includes a flash column, wherein the flash column includes a heating system to bring a bottoms temperature of the flash column to between about 45° C. and about 75° C., an outlet for the aqueous carbonate stream proximate to the bottom of the flash column, an outlet for an acid gas stream proximate to the top of the flash column, and a cooling system to remove heat from the aqueous carbonate stream.

In an aspect, the acid gas stream includes hydrogen sulfide or carbon dioxide, or both.

In an aspect, the acid gas includes hydrogen sulfide, and the bottoms temperature of the flash column is maintained between about 70° C. and about 75° C.

In an aspect, the acid gas includes carbon dioxide, and the bottoms temperature of the flash column is maintained between about 55° C. and about 65° C.

In an aspect, combinable with any other aspect, the heating system includes a solar concentrator.

In an aspect, combinable with any other aspect, the cooling system includes a heat exchanger placed under a surface of a body of water.

In an aspect, combinable with any other aspect, the acid gas stream is a product stream.

In an aspect, the catalyst includes magnesium, calcium, or beryllium, or a combination thereof. In an aspect, the mass concentration of the catalyst is between about 10 microgram per Liter and 500 milligram per Liter.

In an aspect, the mass concentration of the catalyst is between about 100 microgram per Liter and 100 milligram per Liter.

In an aspect, combinable with any other aspect, the aqueous carbonate stream includes an alkaline metal or an amine or a combination thereof. In an aspect, the alkaline metal includes lithium, sodium, potassium, cesium, or rubidium, or any combinations thereof. In an aspect, the amine is a heteroaromatic amines, a hindered amine, or both.

Another embodiment described herein provides a method for removing an acid gas from a sour stream. The method includes introducing a gas proximate to a bottom of a contactor, wherein the gas includes a mixture with an acid gas. An aqueous carbonate stream is introduced proximate to a top of the contactor, wherein the aqueous carbonate stream includes a monovalent ion and an alkaline earth ion. The gas and the combined aqueous stream are contacted in a countercurrent flow in the contactor, forming a sweetened gas and an aqueous bicarbonate-carbonate stream. A sweetened gas stream is removed proximate to the top of the contactor. The aqueous bicarbonate-carbonate stream is removed proximate to the bottom of the contactor. The aqueous bicarbonate-carbonate stream is passed through a nanofilter. The permeate stream from the nanofilter is provided to a flash column. The permeate stream is regenerated in the flash column to reform the aqueous carbonate stream. The retentate stream from the nanofilter is introduced to the absorption column.

In an aspect, the acid gas includes carbon dioxide, and the flash column is heated to a temperature of between about 50° C. and about 55° C.

in an aspect, the acid gas includes hydrogen sulfide, and the flash column is heated to a temperature of between about 65° C. and about 75° C.

Other implementations are also within the scope of the following claims.

What is claimed is:

1. An acid gas removal system, comprising:
a contactor, comprising:
an inlet for an aqueous carbonate stream proximate to a top of the contactor, wherein the aqueous carbonate stream comprises a catalyst;
an inlet for a gas stream proximate to a bottom of the contactor, wherein the gas stream comprises an acid gas;
an outlet for an aqueous bicarbonate-carbonate stream proximate to the bottom of the contactor; and
an outlet for a sweetened gas stream proximate to the top of the contactor;
a nanofilter, comprising:
the aqueous bicarbonate-carbonate stream introduced at an inlet;
a permeate stream comprising bicarbonate ions, wherein the permeate stream is fed to a flash column; and
a retentate stream comprising carbonate ions, wherein the retentate stream is fed to the contactor.

2. The acid gas removal system of claim 1, wherein the gas stream comprises natural gas.

3. The acid gas removal system of claim 1, wherein the gas stream comprises air.

4. The acid gas removal system of claim 1, wherein the gas stream comprises a flue gas.

5. The acid gas removal system of claim 1, wherein the sweetened gas stream comprises carbon dioxide depleted air.

6. The acid gas removal system of claim 1, comprising the flash column, wherein the flash column comprises:
a heating system to bring a bottoms temperature of the flash column to between about 45° C. and about 75° C.;
an outlet for the aqueous carbonate stream proximate to the bottom of the flash column;
an outlet for an acid gas stream proximate to the top of the flash column; and
a cooling system to remove heat from the aqueous carbonate stream.

7. The acid gas removal system of claim 6, wherein the acid gas stream comprises hydrogen sulfide or carbon dioxide, or both.

8. The acid gas removal system of claim 6, wherein the acid gas comprises hydrogen sulfide, and the bottoms temperature of the flash column is maintained between about 70° C. and about 75° C.

9. The acid gas removal system of claim 6, wherein the acid gas comprises carbon dioxide, and the bottoms temperature of the flash column is maintained between about 55° C. and about 65° C.

10. The acid gas removal system of claim 6, wherein the heating system comprises a solar concentrator.

11. The acid gas removal system of claim 6, wherein the cooling system comprises a heat exchanger placed under a surface of a body of water.

12. The gas removal system of claim 6, wherein the acid gas stream is a product stream.

13. The gas removal system of claim 1, wherein the catalyst comprises salts of magnesium, calcium, or beryllium, or any combination thereof.

14. The gas removal system of claim 13, wherein the mass concentration of the catalyst is between about 10 microgram per Liter and about 500 milligram per Liter

15. The gas removal system of claim 13, wherein the mass concentration of the catalyst is between about 100 microgram per Liter and about 100 milligram per Liter.

16. The gas removal system of claim 1, wherein the aqueous carbonate stream comprises an alkaline metal or an amine or a combination thereof.

17. The gas removal system of claim 16, wherein the alkaline metal comprises lithium, sodium, potassium, cesium, or rubidium, or any combinations thereof.

18. The gas removal system of claim 16, wherein the amine is a heteroaromatic amines, a hindered amine, or both.

19. A method for removing an acid gas from a sour stream, comprising:
introducing a gas proximate to a bottom of a contactor, wherein the gas comprises a mixture with an acid gas;
introducing an aqueous carbonate stream proximate to a top of the contactor, wherein the aqueous carbonate stream comprises a monovalent ion and an alkaline earth ion;
contacting the gas and the combined aqueous stream in a countercurrent flow in the contactor, forming a sweetened gas and an aqueous bicarbonate-carbonate stream;
removing a sweetened gas stream proximate to the top of the contactor;
removing the aqueous bicarbonate-carbonate stream proximate to the bottom of the contactor;
passing the aqueous bicarbonate-carbonate stream through a nanofilter;
providing the permeate stream from the nanofilter to a flash column;
regenerating the permeate stream in the flash column to reform the aqueous carbonate stream; and
introducing the retentate stream from the nanofilter to the absorption column.

20. The method of claim 19, wherein the acid gas comprises carbon dioxide and the flash column is heated to a temperature of between about 50° C. and about 55° C.

21. The method of claim 19, wherein the acid gas comprises hydrogen sulfide and the flash column is heated to a temperature of between about 65° C. and about 75° C.
